(19) United States
(12) Patent Application Publication
(10) Pub. No.: US 2013/0323143 A1
(43) Pub. Date: Dec. 5, 2013

(54) USING ALKALINE FLY ASH AND SIMILAR BYPRODUCTS IN AN ION-EXCHANGE/REVERSE OSMOSIS PROCESS FOR THE PRODUCTION OF SODIUM CARBONATE

(71) Applicants: Mohammed Olfi, Abu Dhabi (AE); Tarek R. Farhat, Memphis, TN (US)

(72) Inventors: Mohammed Olfi, Abu Dhabi (AE); Tarek R. Farhat, Memphis, TN (US)

(21) Appl. No.: 13/992,569

(22) PCT Filed: Dec. 8, 2010
(86) PCT No.: PCT/IB10/03162

§ 371 Date: Aug. 20, 2013

(51) Int. Cl. B01D 53/62

(52) U.S. Cl. CPC B01D 53/62
USPC 423/181; 422/119

(57) ABSTRACT

The proposed invention uses industrial byproducts such as fly ash in an ion exchange/reverse osmosis (IE/RO) patented technology to sequester carbon dioxide CO2 gas and produce 6 to 7% sodium carbonate (Na₂CO₃) liquor. Similar materials encompass alkaline Fly Ash (AFA) liquor, alkaline red mud (ARM), coal ash, wood ash, and similar natural byproduct materials that are rich in metallic oxides. The process uses AFA or ARM at the input of an IE/RO process where the hydroxides (OH″) get extracted and concentrated for CO₂ gas sequestration. The remaining insoluble byproduct material is used in civil works such as construction and road industry. Ion exchange modules are used to remove all multivalent ionic impurities while a reverse osmosis (RO) skid concentrates the carbonated liquor up to 6 to 7% liquor (or 10% in advanced RO). The process is not an electrochemical chloro-alkali battery nor related to the ammonical Solvay process. The invention is inherently harnessed for carbon capture in the production of soda chemicals from waste alkaline byproducts. There are similarities in the hardware of patent # WIPO Patent App. No. PCT/IB2009/007713.

### TECHNICAL FIELD AND BACKGROUND INFORMATION

Carbon capture is a concept that uses chemicals or any physical process to capture carbon from atmosphere and turn it into solid or liquid. Ideally the concept works if the amount of carbon dioxide (CO₂) released tp atmosphere is equal to the amount of CO₂ sequestered. For example, one of the important hydroxides is CaO which is produced by CaCO3 thermal decomposition where,

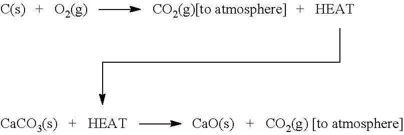

In this process, there are two sources of CO₂ emission, CO₂ released by the burning of coal and CO₂ as a byproduct of the decomposition reaction. We can capture carbon dioxide by reacting CaO with CO₂ (atmosphere) but this cannot be considered carbon capture because a basic commodity material CaO is totally consumed with 1 mole of CO₂ from coal burning is in excess. The same applies for other chemicals such as the alkyl amines and ammonia where CO₂ is released at one stage in the production process. However, for some types of coal the burning process has one more byproduct which is the Alkaline Fly Ash (AFA). The AFA product contains various oxides such as Na₂O, K₂O, CaO, MgO, SrO, . . . which when mixed with water produce alkaline solution of 11<pH<12.5. In solution cations such as Na+, K+, Ca++, Mg++, . . . and the hydroxide ion OH⁻ are present plus other impurities such as sulfates and carbonates. The burning process can be represented as,

C(s)+O₂(g)→CO₂(g)[to atmosphere]+AFA+HEAT

where AFA can be processed to produce an alkaline solution OH⁻, thus

OH⁻+CO₂(g)[from atmosphere]→CO₃²⁻ or HCO₃⁻

Effectively, the above can be considered a carbon capture process because no energy penalties were paid in the production of basic chemicals for CO₂ sequestration. Effectively, with the introduction of AFA we can refer to the net release of CO₂ to the atmosphere where ideally,

CO₂(net)=CO₂(release by burning) CO₂(sequestered by AFA).

In the real world attempts were made to sequester CO₂ with Fly Ash by direct purging of the CO₂ gas with Fly Ash Slurry [1,2,3,4] but no carbonate or bicarbonates can be collected and the efficiency is low. Our Ion Exchange/Reverse Osmosis patented setup would allow the production of carbonates with some energy penalty.

The invention uses alkaline fly ash (AFA) a waste product of power plants that operate on certain types of coal. It can also use alkaline red mud (ARM) a byproduct waste of aluminum industry or similar. The novelty in this invention is that no prior work used AFA or similar byproduct (i.e. ARM) as an input or feed chemical in an Ion Exchange/Reverse Osmosis patented setup to sequester CO₂ a greenhouse gas released to the atmosphere.

The invention accommodates several stages,
(1) Stage 1, AFA or ARM processing:
   To a specific mass of powder AFA or ARM a specific volume of water is added and the slurry is slowly stirred in a steel tank equipped with a pH meter. The pH is monitored to read the highest pH (i.e. pH>11). The tank is equipped with slurry and micron filters that should separate the wet byproduct from the alkaline solution. The wet byproduct goes to other applications (i.e. construction or road works) while the alkaline solution is turned to stage 2.
(2) Stage 2, Ion exchange processing of AFAS:
   The alkaline solution AFA or AR that might contain ions of Na+, K+, Ca++, Mg++, . . . and the hydroxide ion OH— plus other impurities such as sulfates, phosphates, and carbonates is passed 1^{st} through an anion exchanger to remove all the divalent and trivalent anions of sulfates, phosphates, and carbonates and get them replaced by chlorides. Next, the AFAS liquor is passed through a cation exchanger to remove the divalent and trivalent cations such as Ca++, Fe+++, . . . and have these replaced by Na+. The alkaline liquor is now transformed largely to ˜0.1% NaOH solution ready to go into the 3^{rd} stage. Both the anion and the cation exchangers after many cycles of operations, say 50, can be regenerated by brine water (i.e.>6% NaCl) that usually comes out as a waste product of the power plants.
(3) Stage 3, concentrating the 0.1% NaOH liquor:
   The 3^{rd} stage is a combined action of thermal heating, reverse osmosis, and solar vacuum evaporation. Flue gas chimneys that are inverted downwards towards cooling reservoirs which contain the 0.1% NaOH liquor dissipate their waste heat to the NaOH liquor increasing its temperature to ˜35° C. and at the same time cools the flue gas ready to go through a commercial acidic scrubber. The acid free flue gas that comes out of the acidic scrubber and contains CO₂ is then sparged using a commercial liquid-gas sparger with the heated 0.1% NaOH liquor to lower the pH to 8. The NaOH liquor is transformed to a soda carb liquor which is a sodium carbonate Na₂CO₃ solution. The warm soda carb liquor is passed through into a high pressure reverse osmosis unit (HPRO) and unlike commercial RO operated on a cyclic mode. Here a skid of RO cartridges designed in a cascaded mode to do multiple concentration of the reject or the retentate. In the cyclic mode the reject is passed back to the CO₂-liquor sparger for continuous pH adjustment until the TDS meter connected to the sparger reads between 3 to 4% brix ready to go into a final stage that converts the 3.5% liquor to 7% liquor at a maximum of 50% efficiency in the cascaded mode. The soda carb 7% liquor is evaporated by an efficient state-of-the art evaporator until the soda carb salts start precipitating where these get continuously filtered out as more 7% liquor is added. In fact, there are HPRO systems that operate at 1400 psi and can concentrate the reject or the reject up to 10%.

The major advantage in the disclosed carbon capture process shows that no outside chemicals being used to sequester the emitted CO₂ from the power plant. For example, the AFA, ARM, or similar process does not use pure chemicals such as ammonia or alkylamines in various forms, NaOH, Ca(OH)2, or CaO to remove CO₂ from flue gas. Note, in reality the process might need make up CaO or Ca(OH)2 to achieve the required hydroxide content prior to IE/RO processing all depends on the type of alkaline Fly Ash or red mud used. The said process does not consume large energy as in CO2 underground storage or CO₂ liquefaction. The patented process simply uses its own waste byproducts to sequester CO₂ and lowers CO₂ emission into the atmosphere.

### SUMMARY OF THE INVENTION

The mechanism of sodium carbonate Na₂CO₃ production follows a similar scheme as in patent WIPO Patent App. No. PCT/IB2009/007713 where, The invention in the Enpro/ESL process uses alkaline fly ash (AFA) a waste product of industrial and coal fired power plants that operate on certain types of coal. It can also use alkaline red mud (ARM) a byproduct waste of aluminum industry. At this stage of operations ENGSL present the schematic in, FIG. 1, to conduct its CO₂ sequestration with the production of carbonate solids. Note, the usage of AFA or ARM wouldn't have been applicable to CO₂ sequestration without using the ENGSL Ion Exchange/Reverse Osmosis patented process. However, there are facts to consider before considering such applications.

### Technical Problem

Although tens of millions of tons of fly ash goes to construction and road industries, there are also tens of millions of tons of useful AFA disposed off every year in landfills or mines. These can be obtained for free or even charged on the generator plant as fees for helping in its removal. Countries such India and China can be a good source of AFA however if waste AFA is available locally from power plants and other industries it can be used as well. The same applies for red mud which is dumped in millions of tons in landfills all around the world and can be a major hazardous waste.

### Solution to the Problem

The ENGSL AFA or ARM processing technology is expected to cut down on Ca(OH)₂ usage to less than 10% depending on the quality of AFA or ARM used in its IE/RO process while at the same time consumes CO2 gas.

Alkaline byproduct processing Unit: The said unit is similar in design to a commercial quick-lime processing unit where the powder is subjected to mixing and filtering to collect the alkaline filtrate with pH>12, FIG. 1. The colloidal suspension can be treated with centrifuge filter to collect the processed byproduct paste in silos for usual applications. For low grade fly ash make up Ca(OH)₂ powder can be added to maintain a proper pH.

Ion exchange system: Would receive the alkaline liquor (e.g. ˜0.9 g/L) to produce dilute caustic soda liquor at 1000 ppm concentration. The ion exchange battery is of dual purpose where,

R—SO₃⁻Na⁺+M²⁺→R—SO₃⁻M²⁺+Na⁺

R—(R₂)N⁺Cl⁻+Aⁿ⁻→R—(R₂)N⁺Aⁿ⁻+Cl⁻

Reactors design: Carbon dioxide gas is sparged through caustic soda NaOH in a reactor to form a dilute sodium carbonate liquor Na2CO3 (e.g. 700 ppm Na2CO3 to 300 ppm NaOH). The latter is then subjected to further filtration to remove impurity particulates then passed to reverse osmosis system. The low % liquor needs to be converted and concentrated to higher % sodium carbonate NaOH liquor (e.g. 2400 ppm Na₂CO₃ to 1000 ppm NaOH) by passing it to a reverse osmosis system.

Reverse osmosis (RO) unit contains RO cartridges cascaded with the CO₂-NaOH reactors in between. The objective is to keep the NaOH concentration below 300 ppm as the concentration of Na₂CO₃ is increased. The concentration process should keep going until a 6% to 7% Na₂CO₃ solution, FIG. 2, (not soda ash powder) is obtained. At this point Na₂CO₃ solution (i.e. 3.5% or 6%) if evaporated by an efficient evaporator would produce dry soda ash. In a typical process analysis the following tabulated data can be obtained by computer simulation. The table below presents the data per 2 to 3 tons consumption of Alkaline Fly Ash (or Red Mud) of pH>12 in the production of Na₂CO₃ obtained by computer simulation.

| | | | | |
|---|---|---|---|---|
| Volume flow of circulated liquor | | | 1000 | m3/hr |
| Mass flow of Fly Ash added | | | 2-3 | ton/hr |
| Mass flow of CO2 sequestered | 594.5946 | kg/hr | 0.6 | ton/hr |
| Mass of Na2CO3 produced | 1301.885 | kg/hr | 1.3 | ton/hr |
| Mass flow of 7% NaCl | 1580.626 | kg/hr | 1.6 | ton/hr |
| Total power consumption | | | 0.6 | MWH |

Ion exchangers that are used in this process are regenerated from either the brine of desalinated seawater, any source of brine water, or prepared brine water. In the above schematic, if brine water salinity C is >8% then a desalination plant is not necessary. Otherwise, brine water concentration 6%<C<9% salinity can be obtained from the reject of an RO desalination plant to eliminate the calcium, magnesium, and any multivalent ions thus wash the regenerated ion exchange and convert it to the Na+ form. One important aspect about this process is the circulation of the RO permeate which saves on pure water production and chemicals supply. There are waste products such as calcium chloride and magnesium chloride that can be diluted with pure water produced from the complex membrane and heat exchanger system and returned back to the sea without harming the marine environment. The net production of potable water is difficult to estimate at this stage and depends on the government tolerance level of Ca++, Mg++salts after dilution.

### Advantageous Effects of the Invention and Industrial Applicability

Excessive release of carbon dioxide CO₂ into the atmosphere is a major problem faced by human communities worldwide. The proposed invention attempts to bring this problem to a partial green solution while making a financial benefit. The green solution fulfilled by using alkaline fly ash (AFA) or alkaline red mud (ARM) instead of any pure industrial alkaline chemical at the input of an Ion Exchange/Reverse Osmosis patented process. The financial benefit comes from selling the soda ash chemical as byproduct of the combined processes. In a sense the production of soda ash by the said invention is a new process for the production of three commodity soda chemicals, NaHCO3, Na2CO3, and NaOH. The said patented process would consume less energy and purified start up chemicals than all exiting technologies for the production of these soda chemicals. Other issues such as safety problems in the chloro-alkali cell process tied up to chlorine production, poisonous gas storage, or poisonous gas handling such as ammonia in the Solvay process is eliminated. The soda ash production from alkaline fly ash (AFA) or alkaline red mud (ARM) process is most convenient for industries that emit brine water (i.e. salinity between 6 to 10%) with available waste heat and CO₂ emission sources. Examples, include industrial plants, coal fired power plants, and solid waste incineration plants. There are industrial processes that require one of the soda chemicals at one stage of the production process thus the patented processes can be harnessed in CO₂ sequestration and the provision of caustic soda, baking soda, and soda ash. Moreover, the demand for AFA or ARM increases worldwide causing a global distribution of the material thus decreasing its local impact on one dumpsite or landfill.

### BRIEF DESCRIPTION OF THE DRAWINGS

FIG. 1 Schematic of Sodium carbonate Na₂CO₃ production unit using Alkaline Fly Ash (AFA) as a starting material for CO₂ sequestration.

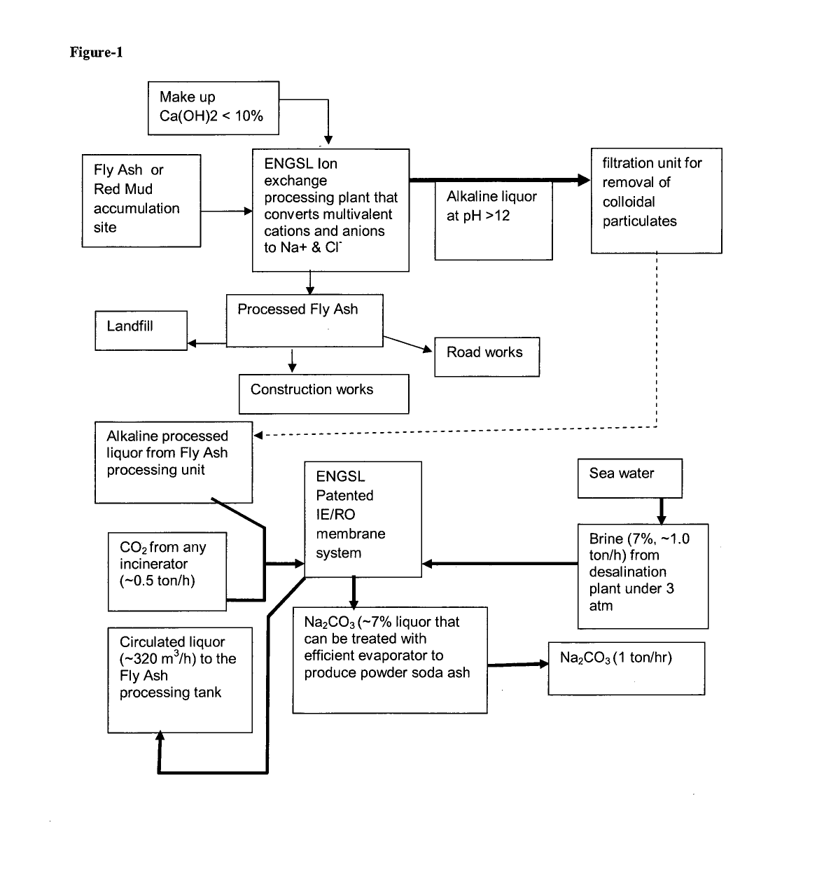

FIG. 2 Schematic of the ion exchange/reactor/reverse osmosis units used in the processing of Fly Ash or Red Mud to extract the hydroxides and produce 7% Na₂CO₃ liquor.

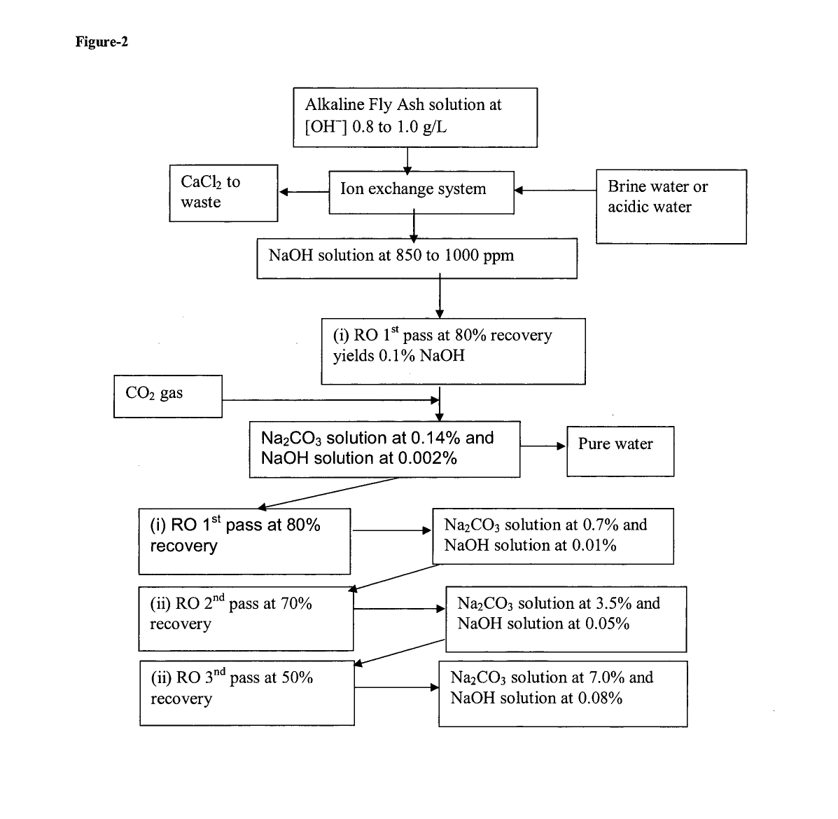

### DESCRIPTION OF THE EMBODIMENT

A copy of Excel worksheet gives detailed mass balance analysis of the entire process starting with the masses of hydroxides involved and required water and ends with the production of 18 kg of soda ash from 75 kg of fly ash.

### REFERENCES

1—Uliasz-Bochenczyk, Alicja; Mokrzycki, Eugeniusz; Piotrowski, Zbigniew; Pomykala, Radoslaw, “Estimation of CO2 sequestration potential via mineral carbonation in fly ash from lignite combustion in Poland”. Energy Procedia, (2009), 1(1), 4873-4879.
2—Uliasz-Bochenczyk, Alicja; Mokrzycki, Eugeniusz, “CO2 sequestration with the use of fly ash from hard coal and lignite combustion”. Slovak Geological Magazine, (2009), Volume Date 2008, (Spec. Issue), 19-22. [Journal written in English].
3—Montes-Hernandez, G.; Perez-Lopez, R.; Renard, F.; Nieto, J. M.; Charlet, L. “Mineral sequestration of CO2 by aqueous carbonation of coal combustion fly-ash.”, Journal of Hazardous Materials, (2009), 161(2-3), 1347-1354.
4—Soong, Y.; Fauth, D. L.; Howard, B. H.; Jones, J. R.; Harrison, D. K.; Goodman, A. L.; Gray, M. L.; Frommell, E. A., “CO2 sequestration with brine solution and fly ashes” Energy Conversion and Management, (2006), 47(13-14), 1676-1685.

1-3. (canceled)

4. A method of producing a sodium carbonate solution in a chemical processing system, comprising;
producing an alkaline solution using an alkaline waste product or an alkaline industrial byproduct;
passing the alkaline solution through a first ion exchange system, the first ion exchange system including an anion exchanger;
passing the alkaline solution through a second ion exchange system to produce a caustic soda liquor, the second ion exchange system including a cation exchanger;
thermally heating the caustic soda liquor;
passing an acidic gas through the caustic soda liquor to produce a dilute sodium carbonate solution; and
filtering the dilute sodium carbonate solution through a filtration system until a predetermined concentration is reached.

5. The method of claim 4, wherein the alkaline waste product or alkaline industrial byproduct comprises an alkaline ash, and wherein the act of producing alkaline solution comprises mixing the alkaline ash with water.

6. The method of claim 5, further comprising monitoring a pH of the alkaline solution.

7. The method of claim 6, wherein the pH is greater than 11.

8. The method of claim 5, wherein the alkaline ash includes at least one of Alkaline Fly Ash, Alkaline Red Mud, Alkaline Wood Ash and Alkaline Coal Ash.

9. The method of claim 4, wherein the concentration of the sodium carbonate solution is between about 6% to about 10%.

10. The method of claim 4, wherein the acidic gas comprises carbon dioxide gas.

11. The method of claim 4, wherein the passing the alkaline solution through a first ion exchanger further includes replacing multivalent anions with chlorides, and wherein the passing the alkaline solution through a second ion exchanger further includes replacing multivalent cations with sodium.

12. The method of claim 4, wherein the concentration of the caustic soda liquor is about 1000 ppm, and wherein the concentration of the dilute sodium carbonate solution is 700 ppm.

13. The method of claim 4, wherein the filtration system includes a high pressure reverse osmosis system.

14. A chemical processing system, comprising;
an alkaline byproduct processing unit configured to mix an alkaline waste product or an alkaline industrial byproduct with water to produce an alkaline solution and monitor a pH of the alkaline solution;
an first ion exchange system configured to replace the multivalent anions with a univalent anion, the first ion exchange system including an anion exchanger;
a second ion exchange system configured to replace the multivalent cations with a univalent cation to produce a caustic soda liquor, the second ion exchange system including a cation exchanger;
a reactor configured to receive an acid gas and the soda liquor, thermally heat the soda liquor, and pass acidic gas through the soda liquor to produce a sodium carbonate solution; and
a filtration system configured to filter the sodium carbonate system.

15. The system of claim 14, wherein the alkaline ash includes at least one of Alkaline Fly Ash, Alkaline Red Mud, Alkaline Wood Ash and Alkaline Coal Ash.

16. The system of claim 15, wherein the pH of the alkaline solution is greater than 11.

17. The system of claim 14, wherein the univalent anion includes chlorides.

18. The system of claim 14, wherein the univalent cation includes sodium.

19. The system of claim 14, wherein the acidic gas comprises carbon dioxide gas.

20. The system of claim 14, wherein the filtration system comprises a high pressure reverse osmosis system.

21. The system of claim 20, wherein the filtration system is further configured to cycle the sodium carbonate solution through the system until a predetermined concentration is reached.

22. The system of claim 21, wherein the final concentration of the sodium carbonate solution is between about 6% to about 10%.

23. The system of claim 21, wherein the filtration system is further configured to circulate the permeate back to the alkaline byproduct processing unit.
